(19) United States
(12) Patent Application Publication
(10) Pub. No.: US 2017/0140455 A1
(43) Pub. Date: May 18, 2017

(54) Systems and Methods for Location-Based Fuel Distribution

(71) Applicant: Andrew Hajime Tryba, El Dorado Hills, CA (US)

(72) Inventor: Andrew Hajime Tryba, El Dorado Hills, CA (US)

(21) Appl. No.: 15/408,522

(22) Filed: Jan. 18, 2017

Related U.S. Application Data
(63) Continuation of application No. 14/070,244, filed on Nov. 1, 2013, now abandoned.
(60) Provisional application No. 61/721,590, filed on Nov. 2, 2012.

(51) Int. Cl. G06Q 30/06; G06Q 30/04

(52) U.S. Cl. CPC G06Q 30/0633; G06Q 30/04

(57) ABSTRACT

Presently disclosed are systems and methods for location-based fuel distribution. One embodiment takes the form of a method of delivering fuel to a vehicle, including a fuel mobile app that registers the vehicle location and requests the fuel service, a gateway and authentication server, a location server, a dispatch server, a real-time fuel price server, a back-end server, and a database. These systems communicate with an application associated with a fuel service vehicle that then dispatches and delivers fuel to the vehicle. Additionally, the back-end server may be configured to bill a customer for the receipt of fuel.

### CROSS REFERENCE TO RELATED APPLICATION

The present application claims priority to both U.S. patent application Ser. No. 14/070,244, filed on Nov. 1, 2013 and U.S. Provisional patent application Ser. No. 61/721,590, filed on Nov. 2, 2012, the entire contents of each are herein incorporated by reference.

### BACKGROUND

The present disclosure relates to fuel distribution, and more particularly to coordinating and accomplishing delivery of fuel to a vehicle.

### SUMMARY

Presently disclosed are example systems and methods for delivering fuel to a vehicle in part by making use of an application on a mobile communication device (e.g., a cellular telephone) or other device (perhaps associated with and/or integrally formed with the vehicle) that registers the vehicle location to one or more cloud servers, which in turn may relay the vehicle location and customer information to a fuel vehicle that is dispatched to the location. The fuel vehicle deposits fuel to the customer vehicle and bills for the fuel and service. The user, driver, and/or company associated with the user and/or driver may then be billed at the site of the refueling, electronically at some other location, and/or in one or more other suitable manners of billing known in the art.

### BRIEF DESCRIPTION OF THE DRAWINGS

FIG. 1 illustrates an example environment and architecture for requesting and delivering fuel to the vehicle.

FIG. 2 illustrates a flowchart of an example method for requesting and delivering fuel to the vehicle.

### DETAILED DESCRIPTION

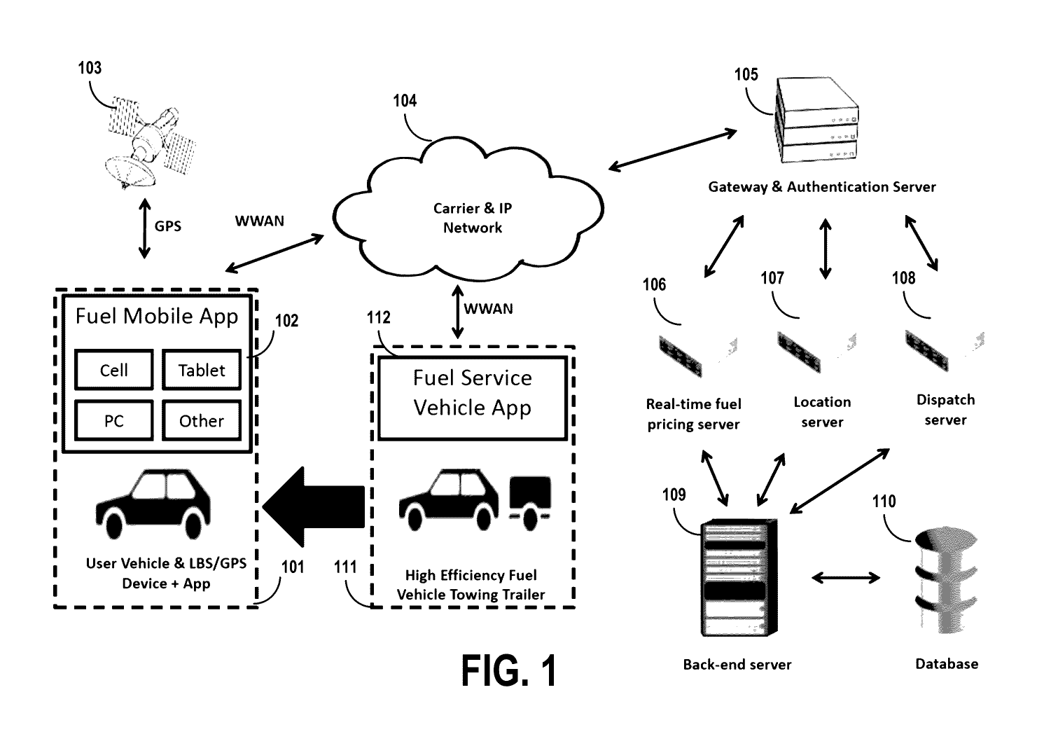

Referring now to the figures, in FIG. 1 there is a user vehicle 101 associated with a fuel mobile app 102. The fuel mobile app 102 may register a location based on GPS 103. The fuel mobile app 102 may also request a fuel service through the cloud servers 104-110. The cloud servers 104-110 communicate to a fuel service app 112. The fuel service app 112 is associated with a fuel service vehicle 111 that then dispatches and delivers fuel to the vehicle 101.

In more detail, still referring to FIG. 1, the user vehicle 101 includes or is otherwise associated with a device that executes the fuel mobile app 102. This fuel mobile app 102 can be run on a variety of devices including cellphones, tablets, PCs, automobile computers, and/or one or more other devices. The fuel mobile app 102 registers the location of the user vehicle 101 via GPS and/or other geo-location service and through communication over a carrier or IP network 104 to a gateway and authentication server 105. A GPS unit may be located in either the hardware that executes the fuel mobile app 102 or in the vehicle 101 itself. If the GPS unit is located in the vehicle 101, the vehicle 101 may be configured to communicate its location based on the GPS to either the hardware that executes the fuel mobile app 102 or to a server. In various embodiments, the location technology utilized locally by the fuel mobile app 102 may be executed by a user's mobile device, by the vehicle itself, by a separate location-determination device, and/or any suitable combination thereof. In some embodiments, the user may manually enter an exact or approximate location, such that automated location-determination technology is not necessary in every embodiment.

In the illustrated example, the gateway and authentication server 105 relays the location information (and in some embodiments user information) to a location server 107, which translates and conveys the information to a back-end server 109. The back-end server 109 may associate user information, such as a mobile-device identification, billing information, vehicle information, etc., in a database 110 and communicate to a real-time fuel price server 106 to convey at least the fuel information and current location. The back-end server 109 may also communicate to a dispatch server 108, which combines user requests based on consideration of similarities and differences as to parameters such as fuel type, user location, fuel truck location, quantity of fuel, and the like. Although the various servers 105-109 are shown as different server elements, a single server unit, or other computing device, may perform the functionality shown with respect to servers 105-109.

The dispatch server 108 may in turn communicate to the fuel server vehicle app 112 that is associated with the fuel service vehicle 111. The dispatch server 108 may also communicate back to the fuel mobile app 102 a confirmation, approximate time of delivery, and/or other relevant information. The fuel service vehicle 111 may then be dispatched to the user vehicle 101 location, where the fuel may then be dispensed into the user vehicle 101. Upon completion, the fuel service vehicle app 112 may then report the fuel dispensing information back to the back-end server 109 and database 110, for record keeping, bill generation, and/or one or more other purposes.

In further detail, still referring to FIG. 1, the user vehicle 101 could be any of a variety of personal and/or commercial vehicles such as cars, trucks, motorcycles, tractors, construction equipment, boats, aircraft, and the like. The user vehicle 101 can be delivered gasoline, diesel, recharge of electric batteries, and/or other types of fuel from various different fuel sources. The fuel service vehicle 111 can be or include a truck, car, trailer, a boat, an aircraft, and/or any vehicle suitable to deliver fuel to the user vehicle 101.

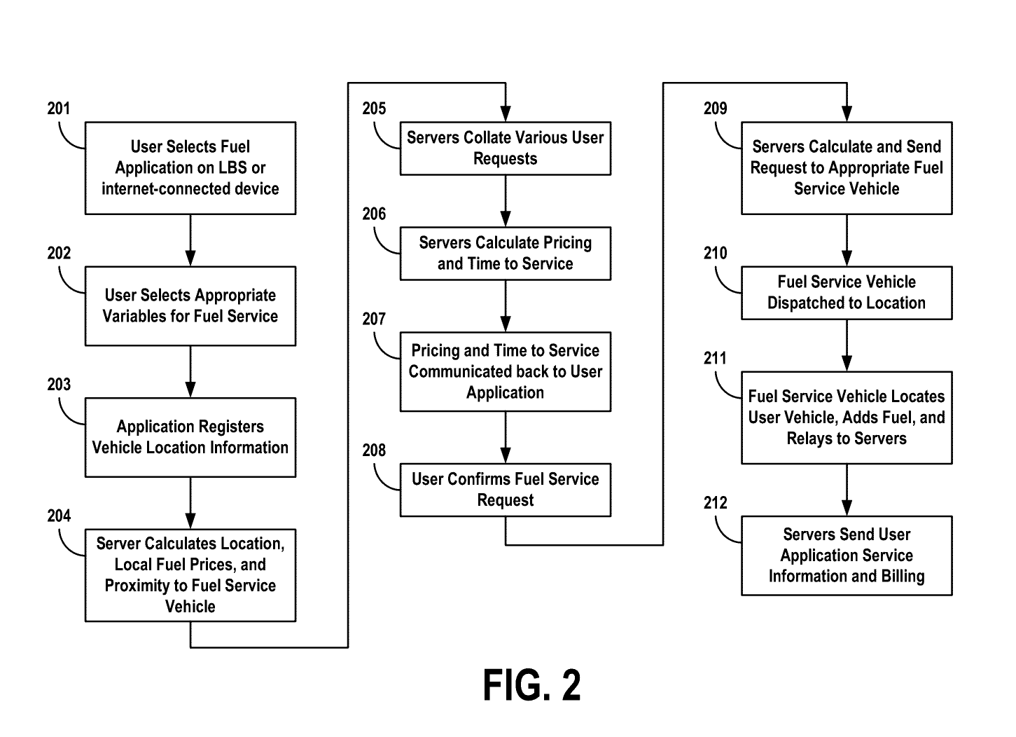

Referring now to FIG. 2, a flowchart of an example method for requesting and delivering fuel to a vehicle is illustrated. Although the blocks of FIG. 2 are shown in a linear arrangement, in various examples, some of the blocks may be performed in parallel (e.g., at the same time). In additional embodiments, the steps may be performed at different times. For example, a user may establish an account that includes both vehicle data and billing information, and thus when a fuel-request is performed, the user may not have to provide information associated with the user's account.

The process starts (at 201) with the user or automated device starting the fuel service application 102 on an internet connected device. (For brevity, user selection is used by way of example in the ensuing description.) The user then selects (at 202) the vehicle and type of fuel to be delivered to the user vehicle 101. The fuel mobile application 102 then registers (at 203) the user vehicle 101 location. The servers 105-110 calculate (at 204) the location, local fuel prices & proximity to the fuel service vehicle 111. The servers collate (at 205) the various user requests utilizing location and other variables, and then calculate (at 206) the pricing & time to service. This pricing and time to service is communicated (at 207) back to the user application 102 where a user-initiated or automated confirmation for fuel service occurs (at 208). The servers 105-110 send (at 209) appropriate dispatch information to the fuel service vehicle 111. The fuel service vehicle 111 is then dispatched (at 210) to the location of the user vehicle 101. The fuel service vehicle 111 locates (at 211) the user vehicle 101 and adds fuel (still at 211). This fuel can be a variety of types including gasoline, diesel and electric car recharges. Upon completion, the fuel service vehicle 111 utilizes the fuel service vehicle app 112 to relay (still at 211) the data back to the servers 105-110 for storage in the database 110. The servers 105-110 send (at 212) completion and billing data back to user fuel mobile application 102.

The advantages of the presently disclosed systems and methods include, without limitation, benefits to both the user of the service and the fuel distributor. In prior contexts, users of vehicles in need of fuel would be required to go to local gas stations or other locations for fuel. With the benefit of the presently disclosed systems and methods, however, users of vehicles in need of fuel can now take advantage of location-based services and have fuel delivered to their vehicle while parked. This advantage enables the users to save time and money.

Additionally, the mobile application may display the fuel prices available at local gas stations as well as display the delivery price. On the fuel distributor side, in prior contexts, their customers would have to come to their location for fuel to be distributed and sold. This need for customers to come to their location limited the customer base and geographical reach. With the benefit of the presently disclosed systems and methods, however, fuel distributors can extend their services outside of their station location to reach customers that may or may not have come to their physical location. The mobile application will display the fuel prices available at their service station as well as additional messages appropriate for the user of the service. This monetization is currently supplemental to their fixed location model and enables the fuel distributors to develop further insight and relationships with their customer base.

In at least one embodiment, the presently disclosed systems and methods take the form of a method or process of delivering fuel directly to a vehicle rather than requiring the vehicle to come to where the fuel is stored. In some cases, the presently disclosed systems and methods involve franchising of the distribution of fuel directly to the user vehicle.

In some embodiments, the disclosed methods may be implemented as computer program instructions encoded on a non-transitory computer-readable storage media in a machine-readable format, or on other non-transitory media or articles of manufacture. For example, a server or mobile device may execute the computer program instructions. In one embodiment, the example computer program product is provided using a signal-bearing medium. The signal-bearing medium may include one or more programming instructions that, when executed by one or more processors may provide functionality or portions of the functionality described above with respect to FIGS. 1-2. In some examples, the signal bearing medium may encompass a non-transitory computer-readable medium, such as, but not limited to, a hard disk drive, a Compact Disc (CD), a Digital Video Disk (DVD), a digital tape, memory, etc.

The one or more programming instructions may be, for example, computer executable and/or logic implemented instructions. In some examples, a computing device such as the a server of FIG. 1 may be configured to provide various operations, functions, or actions in response to the programming instructions conveyed to the computer system by one or more of the computer readable medium, the computer recordable medium, and/or a communications medium.

The non-transitory computer readable medium could also be distributed among multiple data storage elements, which could be remotely located from each other. The computing device that executes some or all of the stored instructions could be a mobile device, a vehicle, or other computer device. Alternatively, the computing device that executes some or all of the stored instructions could be another computing device, such as a server.

While the foregoing written description of the presently disclosed systems and methods enables one of ordinary skill to make and use what is presently considered to be the best mode thereof, those of ordinary skill will understand and appreciate the existence of variations, combinations, and equivalents of the specific embodiments, methods, and examples herein. The scope of the presently disclosed systems and methods should therefore not be limited, and rather are merely illustrated by the above described embodiments, methods, and examples.

I claim:

1. A system comprising a server comprising a signal bearing medium and a processor, wherein the processor of the server is configured to:
communicate to a device, based on a location of a vehicle determined based on a global position system (GPS) signal, both (i) at least one fuel price available at a gas station and (ii) a fuel delivery price;
receive a fuel request from the device, wherein the fuel request comprises the location of the vehicle;
associate the fuel request with an account;
communicate to a fuel delivery vehicle:
the location of the vehicle,
a dispatch request, and
data specific to the vehicle, wherein the vehicle is associated with the account;
receive communication from the fuel delivery vehicle that a refueling is complete;
update the account for the refueling; and
communicate a refueling confirmation to the device.

2. The system of claim 1, wherein the account contains information related to:
the vehicle for refueling;
the device configured to communicate the fuel request; and
at least one means of billing associated with the account.

3. The system of claim 1, wherein the server is further configured to:
communicate fuel prices to the device associated with a plurality of fuel services;
receive a selection of one of the plurality of fuel services from the device.

4. The system of claim 1, wherein the server is further configured to communicate an approximate time of fuel delivery to the device.

5. The system of claim 1, wherein the GPS signal is received by the vehicle.

6. The system of claim 1, wherein the GPS signal is received by the device.

7. The system of claim 1, wherein the fuel request comprises a request for one of gasoline, diesel and electric charge.

8. A method of providing a refueling service for a vehicle comprising:
communicating to a computing device, based on a location of a vehicle determined based on a global position system (GPS) signal, both (i) at least one fuel price available at a gas station and (ii) a fuel delivery price;
receiving, from the computing device, a fuel request from the device, wherein the fuel request comprises the location of the vehicle;
the server responsively:
associating the computing device with an account;
communicating the location of the vehicle to a fuel delivery vehicle;
communicating data specific to a vehicle associated with the account to the fuel delivery vehicle;
communicating a dispatch request to a fuel delivery vehicle;
receiving communication from the fuel delivery vehicle that a refueling is complete;
billing the account for the refueling; and
communicating a refueling confirmation to the computing device.

9. The method of claim 8, wherein the account contains information related to:
the vehicle for refueling;
the computing device configured to communicate the fuel request; and
at least one means of billing associated with the account.

10. The method of claim 8, wherein the server is further configured to:
communicate fuel prices to the device associated with a plurality of fuel services;
receive a selection of one of the plurality of fuel services from the computing device.

11. The method of claim 8, wherein the server is further configured for communicating an approximate time of fuel delivery to the device.

12. The method of claim 8, wherein the GPS signal is received by the vehicle.

13. The method of claim 8, wherein the GPS signal is received by the computing device.

14. The method of claim 8, wherein the fuel request comprises a request for one of gasoline, diesel and electric charge.

15. A computing device comprising:
a communication unit configured to send and receive signals; and
an application executable by a processor of the computing device, the application configured to:
receive from a server both (i) at least one fuel price available at a gas station and (ii) a fuel delivery price, wherein both the fuel price available at a gas station and the fuel delivery price are based on a location of the vehicle determined based on a global position system (GPS) signal;
communicate a fuel request to the server, wherein the fuel request comprises the location of the vehicle;
communicate the location of the vehicle to a server;
receive fuel price data associated with a plurality of fuel services from the server;
communicate a selection of one of the plurality of fuel services to the server; and
receive a fuel service confirmation from the server.

16. The computing device of claim 15, wherein the computing device is further configured to receive an approximate time of fuel delivery to the device.

17. The computing device of claim 15, wherein the GPS signal is received by a vehicle associated with the refueling.

18. The computing device of claim 15, further comprising a GPS receiver configured to receive location information for communication to the server.

19. The computing device of claim 15, wherein the fuel request comprises a request for one of gasoline, diesel and electric charge.

20. The computing device of claim 15, wherein the computing device is further configured to communicate account information associated with the fuel request to the server, wherein the account information is associated with billing information.
